(19) United States
(12) Patent Application Publication
(10) Pub. No.: US 2023/0062520 A1
(43) Pub. Date: Mar. 2, 2023

(54) Aeration Device

(71) Applicant: Bullseye Firearms Inc., Homer City, PA (US)

(72) Inventor: James V. Hewitt, Indiana, PA (US)

(73) Assignee: Bullseye Firearms Inc., Homer City, PA (US)

(21) Appl. No.: 17/895,898

(22) Filed: Aug. 25, 2022

Related U.S. Application Data
(60) Provisional application No. 63/238,063, filed on Aug. 27, 2021.

(51) Int. Cl. C02F 3/02; B01F 23/237; B01F 33/503; B01F 23/231

(52) U.S. Cl. CPC C02F 3/02; B01F 23/237611; B01F 33/503; B01F 23/2312

(57) ABSTRACT

An aeration device has an entrainment chamber for mixing air and water in a body of water, wherein the air becomes partially dissolved into the water, thus creating water enriched with dissolved air, and excess air that did not dissolve into the water. An air input introduces air into the aeration device and a water input introduces water into the aeration device. Water enriched with dissolved air exits a water discharge of the aeration device at a first level within the body of water. An air exhaust manifold wherein the excess air can exit the water discharge while remaining inside the aeration device, an exhaust stack that permits the excess air to travel up from the air exhaust manifold, and an exhaust that permits the excess air to exit the aeration device at a second level within or above the body of water.

This patent application claims the priority benefit of U.S. Provisional Patent Application No. 63/238,063 filed on Aug. 27, 2021, which is hereby incorporated by reference in its entirety.

### FIELD OF THE INVENTION

The invention relates to devices for aerating naturally occurring or man-made bodies of water including ponds, lakes, pools, and the like. This invention further relates to the field of aeration and circulation systems for ponds, lakes, sounds, treatment basins and other bodies of water.

### BACKGROUND

Ponds, lakes, pools, and other bodies of water typically exhibit a well-mixed surface layer and a uniformly colder deep layer. It is common for a thermocline to exist. A thermocline is a narrow boundary between the surface layer and the deep layer within a body of water. There is generally significant mixing of the water within the surface layer, as well as within the deep layer. However, there is much less mixing between the two layers. Oxygen enters the surface of the water from the atmosphere, and is also produced by photosynthesis within the water at depths as far down as sufficient light can reach. When light penetration is limited, oxygen production by photosynthesis only occurs in the upper layer. Many bodies of water such as, for example, lakes, estuaries, sounds and treatment basins exhibit very high oxygen demand in the deep layer, resulting in oxygen depletion. The deep layer oxygen consumption rate and oxygen demands at the sediment/water interface can exceed the oxygen replenishment rate from photosynthetic production combined with oxygen dissolution from the atmosphere. This is especially true when atmospheric oxygen and photosynthetically created oxygen exist primarily in the surface layer, and do not penetrate sufficiently into the deep layer.

The loss of dissolved oxygen from waters at various depths can have serious water quality consequences including: loss of desirable habitat for fish and other aerobic aquatic organisms; accumulation of nutrients and anaerobic respiration products such as iron, manganese, hydrogen sulfide, phosphorus, ammonia and other constituents; and increased eutrophication and degradation of resource quality for recreation, habitat, and water supply. Intervention may be desired to increase and enhance aeration to improve and maintain water quality.

However, even though the surface layer may have sufficient oxygen for fish and other animals dependent upon breathing oxygen from the water, the temperature of the surface layer can become high enough to cause stress on such animals. In these higher temperature conditions, the animals need to retreat to the deep layer and its cooler temperatures. However, if the deep layer lacks sufficient dissolved oxygen, these animals cannot thrive if they remain in the deep layer. If conditions of high temperature in the surface layer and lack of oxygen in the deep layer are too extreme, some animals may not survive.

It is an object of the preferred embodiment of the present invention to provide sufficient aeration/oxygenation to the deep layer water, and that aerobic (rather than anaerobic) breakdown of organic compounds in the sediments can occur. It is also an object of the preferred embodiment of the present invention to do this while maintaining the thermocline, so that animals can escape to the colder deep layer water when the temperature of the surface layer is too high.

### BRIEF SUMMARY

The preferred embodiments of the invention provide an improved aeration device for dissolving air into a body of water, by adding dissolved air to the deep layer of the body of water, while minimizing disturbance to the thermocline that separates the deep layer of the body of water from the surface layer of the body of water. An aeration device according to the preferred embodiment has a specially designed entrainment chamber that allows air to become dissolved into the water, discharge this enriched water into the deep layer of the body of water, while simultaneously discharging excess gas into the upper layer of the body of water, or directly into the atmosphere.

### BRIEF DESCRIPTION OF THE DRAWINGS

FIG. 1 is a partial cross-sectional view of an aeration device 1 according to a preferred embodiment of the invention.

FIGS. 2(a), and 2(b) are side views of an aeration device 1 according to a preferred embodiment of the invention.

FIGS. 3(a), 3(b), and 3(c) are from the perspective of view A-A as noted in FIG. 1, showing alternative embodiments of an aeration device 1.

FIG. 4 is a cross-sectional view of an aeration device 1 according to a preferred embodiment of the invention while in operation in a body of water.

### DETAILED DESCRIPTION OF THE PREFERRED EMBODIMENTS

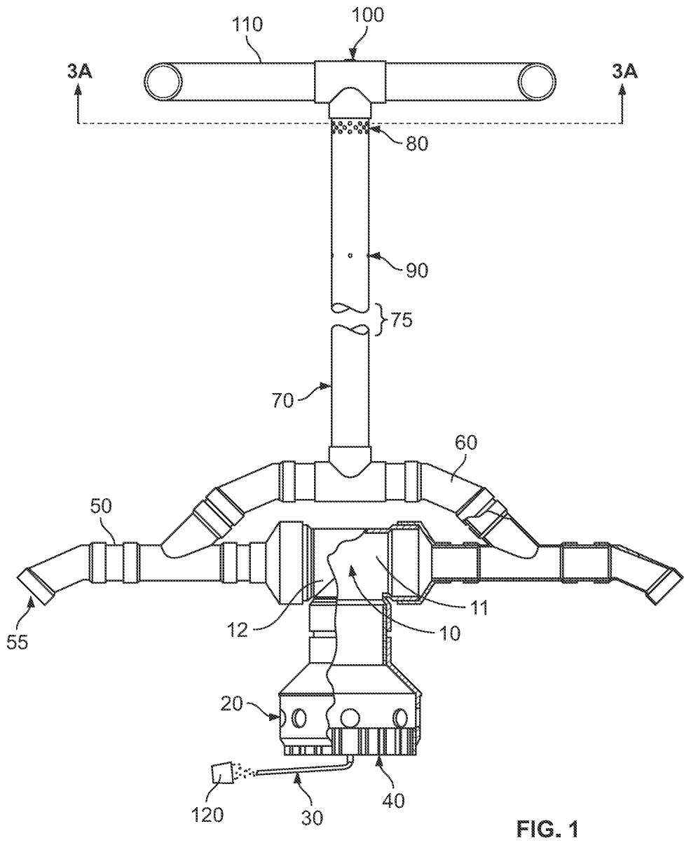

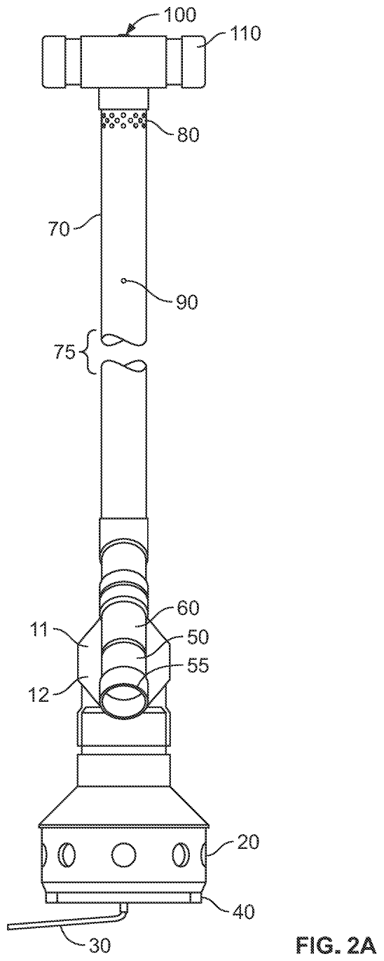

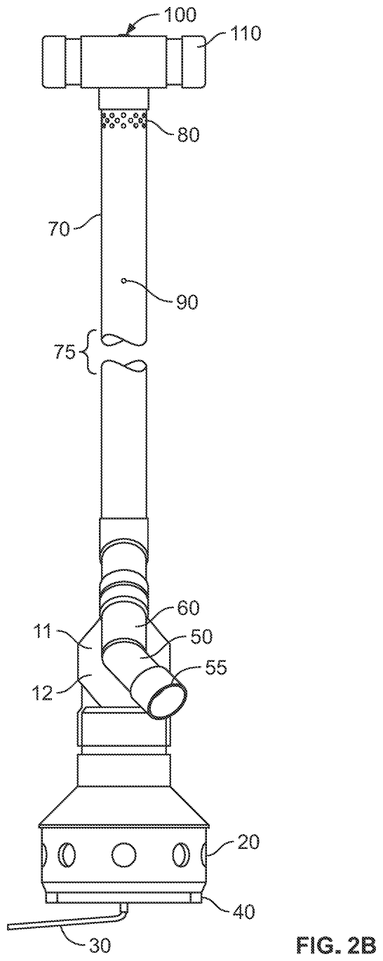

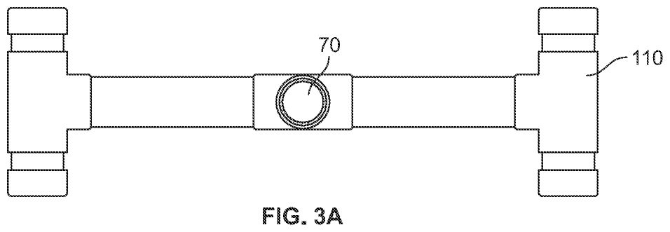

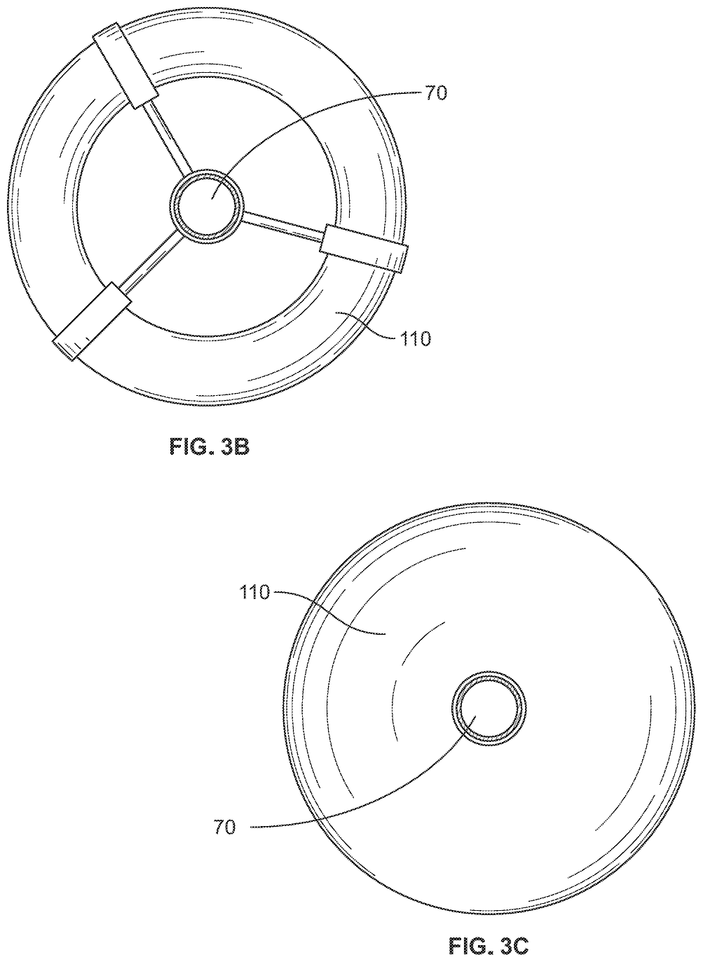

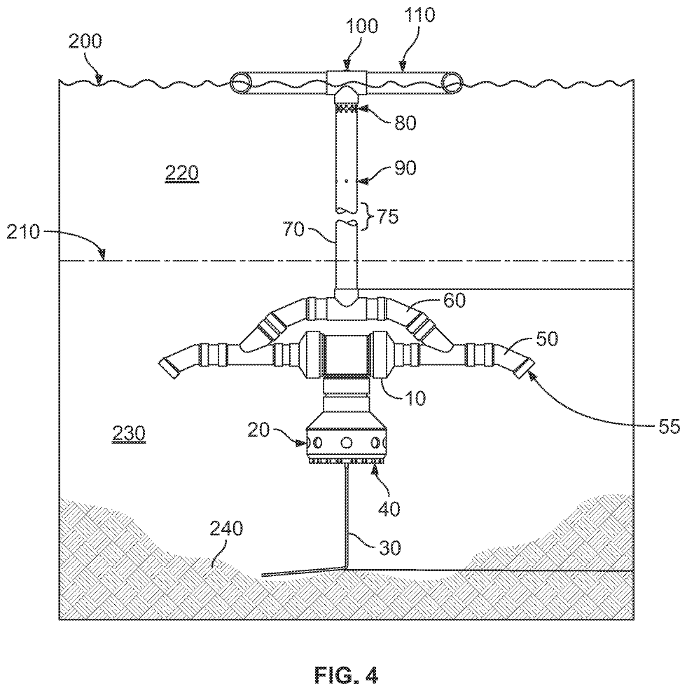

Several embodiments of an aeration device 1 are shown in the accompanying figures. FIGS. 1, 2(a), and 2(b) show an aeration device 1 of the present invention, including the primary components of a preferred embodiment. FIGS. 3(a), 3(b), and 3(c) show alternative preferred embodiments of the present invention. In particular, they show alternative embodiments of the float 110. FIG. 4 shows a preferred embodiment of the present invention as it would be located within a body of water 250 during normal operation.

The aeration device 1 of FIGS. 1, 2(a), and 2(b) includes an entrainment chamber 10, water inlet 20, input line 30, diffuser 40, aerated water discharge 50, air exhaust manifold 60, exhaust stack 70, and float 110.

In a preferred embodiment, normal atmospheric air is introduced into the water aerator through input line 30. If rapid oxygenation is desired, or if the water aerator is being used in a body of water that requires extremely high amounts of extra oxygenation, a gas other than air can be used. For example, a tank of pure oxygen could be attached to the input line 30, and pure oxygen introduced into the aeration device 1. Or, air enriched with oxygen, such as that provided by an oxygen concentrator, can be used. Input line 30 may be constructed of any sufficient material to fulfill its function. The air line 30 may be comprised of flexible or rigid tubing, and, in certain versions, is comprised of flexible plastic. A wide variety of materials, sizes, and constructions are well known to those of skill in the art.

The air line 30 may feed air directly to the diffuser 40 by connecting directly thereto, or feed air indirectly to the diffuser 40 by connecting to a chamber (not shown) connected to the diffuser 40. The air line 30 may be connected to the diffuser 40, or other elements, by various adapter connectors (not shown).

In the preferred embodiment, the air is forced through input line 30 by use of a pump 120. The pump 120 can be any type of pump that will force air, under sufficient pressure, through input line 30 and into the aeration device 1. Preferably, pump 120 will be able to produce air under a pressure from about 2 to 50 psi. More preferably, pump 120 will be able to produce air under a pressure from about 5 to about 12 psi. In one preferred embodiment, a Pentair 12 volt air pump is utilized.

Pump 120 can be in any convenient location, as long as it is properly attached to the aeration device 1 via input line 30. Pump 120 may be an integral part of the aeration device 1. Preferably, pump 120 is outside the body of water 250, and thus avoids the more demanding environmental conditions that would be involved if it were built directly into the aeration device 1. In another preferred embodiment, pump 120 is integrally constructed with or into the float 110. In another preferred embodiment, pump 120 includes solar panels (not pictured) to provide power for the operation of the pump 120. In one preferred embodiment, a Mighty Max 160 watt 12 volt waterproof polycrystalline solar panel is used.

The diffuser 40 accepts air from input line 30 and diffuses it into the liquid inside the aeration device 1 in the form of micro-bubbles. The diffuser 40 generates the micro-bubbles by passing air through perforations in an interface between the air source and the liquid. The diffuser 40 can be constructed from any of a variety of materials, including but not limited to plastics and metals, and can embody any of a variety of shapes. In some versions of the aeration device 1, the diffuser 40 may comprise or consist of sintered silica. In a preferred embodiment, the diffuser 40 is a commercially available rubber membrane diffuser, such as an EDI FlexAir™ fine bubble diffuser. The diffuser 40 can be extended along a longitudinal axis or can embody a compact, substantially symmetrical or asymmetrical shape. The cross-sectional geometry of the diffuser 40 can be round, square, or any other geometric shape.

The air bubbles introduced into the interior of the aeration device 1 through the diffuser 40 will naturally travel upward, and enter the entrainment chamber 10. The entrainment chamber 10 is shaped such that it contains primarily air in upper portion 11, and contains primarily water in lower portion 12. As the air bubbles rise from the diffuser 40 into entrainment chamber 10, the air bubbles will burst through the water's surface at the margin between upper portion 11 and lower portion 12. The majority of the oxygen being transferred from the air bubbles into the water may occur at this point, as the air bubbles burst through and transition from air bubbles in water to the air inside upper portion 11. This action adds extra dissolved air into the water in the lower portion 12 of the entrainment chamber 10, thus enriching it compared to the water that originally entered the aeration device 1 through water inlet 20.

Due to the physical action of the rising air bubbles from the diffuser 40, water is pulled into the aeration device 1 through the water inlet 20. The water inlet 20 can be of any of a variety of sizes and shapes, and there can be a single water inlet 20, or any number thereof. The total size of the one or more water inlet 20 openings is preferably large enough to permit sufficient flow to the inside of the aeration device 1, while not being too large so as to reduce the physical action that is creating the flow of water therethrough.

Due to the continuous inflow of water and air into the entrainment chamber 10, there is likewise a continuous outflow of water and air from the entrainment chamber 10. As the air fills the upper portion 11 of the entrainment chamber 10, it flows outward through the top portion of the aerated water discharge 50. As it flows outward, it comes into contact with an opening into the air exhaust manifold 60. As the enriched aerated water exits the entrainment chamber 10, it flows through aerated water discharge 50 and exits the aeration device 1 through aerated water discharge exit nozzle 55, and is then discharged into the body of water 250. It is important that the aerated water discharge exit nozzle 55 is at the desired level within the body of water 250. Preferably, the aerated water discharge exit nozzle 55 is below the thermocline 210, and the aerated water is discharged into the colder water of the deep layer 230. In particular, the aerated water discharge exit nozzle 55 directs the aerated water to the interface between the colder water of the deep layer 230 and the sediment at the bottom surface 240 of the body of water 250.

In a preferred embodiment of the invention, the aerated water discharge exit nozzle 55 is angled slightly downward, such that the aerated water discharge exit nozzle 55 is noticeably lower than the rest of the aerated water discharge 50. This helps to ensure that the air exiting the entrainment chamber 10, as it travels through the aerated water discharge 50, is entirely guided into the air exhaust manifold 60, and does not exit aeration device 1 through the aerated water discharge exit nozzle 55. This way, it is only aerated water that is discharged from the aerated water discharge exit nozzle 55. If some of the air entering the aerated water discharge 50 bypasses the air exhaust manifold 60 and exits aeration device 1 into the water of the deep layer 230, it will rise through the deep layer 230, through the thermocline 210, and then into the upper layer 220 of water before rising to the surface 200. This could disturb the thermocline 210, and cause undesirable mixing of the warm water of the upper layer 220 with the colder water of the deep layer 230. If too much of this mixing occurs, the deep layer 230 may become warmer than is desired, and no longer exist as a cold water retreat for the fish and other aquatic animals.

In another preferred embodiment of the invention, the aerated water discharge exit nozzle 55 is not only angled slightly downward, but is also angled laterally. In this manner, as the aerated water is discharged through the aerated water discharge exit nozzle 55, it will impart a rotational force to aeration device 1. This force will cause aeration device 1 to slowly rotate as it operates, and thereby discharge aerated water through the aerated water discharge exit nozzle 55 in a manner that yields greater spread and dispersal of this aerated water into the body of water 250. In a further preferred embodiment, the aerated water discharge exit nozzle 55 is adjustable, and can be angled in a more downward or horizontal angle, as desired. It can also be adjustable with respect to its lateral angle, to modify the speed at which aeration device 1 rotates.

As air enters the air exhaust manifold 60, it travels therethrough until it reaches the exhaust stack 70. The function of the exhaust stack 70 is to accept this air, and transfer it internally to one of the air exhausts without disturbing the thermocline 210. The height of the exhaust stack will preferably be selected such that the upper portions of the exhaust stack 70, as well as the air exhausts and the float 110 are above the thermocline 210, while the exhaust stack extends deep enough such that the aerated water discharge exit nozzle 55 is below the thermocline 210. The exact height of the exhaust stack 70 will therefore be selected based upon the depth of the thermocline 210, and the overall depth of the body of water 250 in which it is functioning. In a preferred embodiment, the exhaust stack 70 comprises an exhaust stack adjuster 75 that allows the total height of the exhaust stack 70 to be adjusted so as to achieve an optimal height for the body of water 250 in which it will be operated. Any suitable method of creating an adjustable height may be used, including interconnected telescoping nested tubes.

The air rises through exhaust stack 70 until it reaches one of the air exhausts, either the primary air exhaust 80, secondary air exhaust 90, or the auxiliary air exhaust 100. As aeration device 1 operates, it is expected that the air exhaust manifold 60 and exhaust stack 70 will become largely filled with water. The excess air entering the air exhaust manifold 60 will rise therethrough, enter the exhaust stack 70, rise through that, and exit the aeration device 1 through one of the air exhausts. In a preferred embodiment, this air will rise through the exhaust stack 70 until it reaches the primary air exhaust 80. If the air starts to fill enough of the exhaust stack 70, the top portion of exhaust stack 70 will become filled primarily with air, until the level of this air reaches down to the secondary air exhaust 90. When this occurs, air will exit aeration device 1 through both primary air exhaust 80 and secondary air exhaust 90. Both primary air exhaust 80 and secondary air exhaust 90 may simply be one or more holes in the side of the exhaust stack 70. They may be of any of a variety of sizes, and may consist of one hole, or many holes. In a preferred embodiment, primary air exhaust 80 and secondary air exhaust 90 consist of about 4 to about 40 holes each. However, the presence of the secondary air exhaust 90 is entirely optional, and will generally go unused even if present. The main purpose of the secondary air exhaust 90 is to be a safeguard to release excess air in case the primary air exhaust 80 becomes clogged or otherwise inoperable.

In a similar manner, an optional embodiment of aeration device 1 includes an auxiliary air exhaust 100. This air exhaust is preferably positioned at the highest point of aeration device 1, and allows excess air to exhaust into the atmosphere directly. In a preferred embodiment, the auxiliary air exhaust 100 is a pressure relief valve that only opens when there is sufficient pressure within the exhaust stack 70 to force it open.

The float 110 provides buoyancy for aeration device 1. In a preferred embodiment, the float 110 is connected to the top of the exhaust stack 70. The float 110 can also connect to the aeration device 1 at any other point, as long as it does so in a fashion that maintains aeration device 1 at the proper height within the body of water 250, and maintains aeration device 1 in the proper orientation. The float 110 may be of almost any shape or size, as long as it is sufficiently buoyant to maintain aeration device 1 at the proper height within the body of water 250, and maintains aeration device 1 in the proper orientation. As shown in FIG. 3(a), in one preferred embodiment, float 110 is generally longitudinal in shape, and has an overall shape similar to a capital letter “I”. In another preferred embodiment, shown in FIG. 3(b), float 110 is toroidal in overall shape. In another preferred embodiment, shown in FIG. 3(c), float 110 is a round shape.

The float 110 may comprise any material or combination of materials providing a suitable average density for providing buoyancy in the body of water 250. Some versions of the float 110 include unitary pieces of foam or other low-density materials. Other versions of the float 110 include a vacuumed, or air-contained, fluid-tight container. The container can either be permanently sealed or can be reversibly sealed. A substantially fluid-tight seal maintains a suitable average density by preventing any air contained within the container from leaking into surrounding liquid and by preventing the surrounding liquid from leaking into the container. Yet other versions of the float 110 include a fluid-porous container with air fluxed therethrough. The air fluxing through enables the float 110 to maintain a suitable density by preventing the surrounding liquid from leaking into the container. In such versions, the float 110 and the exhaust stack 70 overlap and may be entirely coextensive. The air fluxing through the fluid-porous container provides suitable buoyancy to create a float 110.

The overall size of the aeration device 1 can vary greatly depending upon the size of the body of water 250 in which it is to operate. The overall height of aeration device 1 will preferably be between about 3 and about 100 feet, and more preferably between about 5 and about 25 feet. The width of the aeration device 1 will preferably be between about 1 foot and 6 feet, and more preferably between about 2 feet and about 4 feet. Most of components of the aeration device 1 are preferably constructed of a durable plastic material, and most preferably from PVC tubing and PVC joints. The component parts of the aeration device 1 may be assembled from dozens of pieces, or assembled from just a very few specially molded pieces.

The term “body of water” as used herein refers to any volume of a liquid in which the aeration device 1 is operating, including liquids that are primarily water. In a preferred embodiment, the body of water 250 does consist of primarily liquid water, such as ponds, lakes, estuaries, and the like. However, the body of water 250 could also be a septic tank, bioreactor, or other man-made structure in which it is desirable to aerate the water.

Though not shown in the Figures, it may also be desirable to include an anchoring component to aeration device 1. If aeration device 1 does not have an anchor or other means to maintain its location laterally within the body of water 250, it could drift or be blown by winds up against the sides of the body of water 250. This could cause aeration device 1 to not operate properly. For example, if the bottom of aeration device 1 comes into contact with the sediment 240 at the bottom of body of water 250, this could prevent the desired rotation of aeration device 1 as it operates. This could also cause aeration device 1 to stir up the sediment 240, which may not be desired. Any type of anchoring system may be utilized, as long as it achieves the function of maintaining the lateral position of aeration device 1 in a desirable location within the body of water 250. The anchoring system should also not otherwise interfere in the proper functioning of the aeration device 1, such as, for example, interfering with its rotation.

The invention claimed is:

1. An aeration device for dissolving gas into a body of liquid, said aeration device comprising:
an entrainment chamber for mixing gas and liquid, wherein said gas becomes partially dissolved into said liquid, thus creating a liquid enriched with dissolved gas, and excess gas that did not dissolve into said liquid;
a gas input for introducing gas into said aeration device;
a liquid input for introducing liquid into said aeration device;
a liquid discharge wherein said liquid enriched with dissolved gas can exit said aeration device at a first level within said body of liquid;
a gas exhaust manifold wherein said excess gas can exit said liquid discharge while remaining inside said aeration device;
an exhaust stack that permits said excess gas to travel away from said gas exhaust manifold; and
an exhaust that permits said excess gas to exit said aeration device at a second level within or above said body of liquid.

2. An aeration device for dissolving air into a body of water, said aeration device comprising:
an entrainment chamber for mixing air and water, wherein said air becomes partially dissolved into said water, thus creating water enriched with dissolved air, and excess air that did not dissolve into said water;
an air input for introducing air into said aeration device;
a water input for introducing water into said aeration device;
a water discharge wherein said water enriched with dissolved air can exit said aeration device at a first level within said body of water;
an air exhaust manifold wherein said excess air can exit said water discharge while remaining inside said aeration device;
an exhaust stack that permits said excess air to travel away from said air exhaust manifold; and
an exhaust that permits said excess air to exit said aeration device at a second level within or above said body of water.

3. The aeration device of claim 2, wherein said body of water comprises a thermocline.

4. The aeration device of claim 3, wherein said first level is below said thermocline.

5. The aeration device of claim 3, wherein said second level is above said thermocline.

6. The aeration device of claim 2, wherein said air input comprises an air pump.

7. The aeration device of claim 6, wherein said air pump delivers air to said aeration device at a pressure range of between 5 and 12 psi.

8. The aeration device of claim 2, wherein said air input comprises a diffuser.

9. The aeration device of claim 8, wherein said diffuser delivers air to said aeration device in the form of micro-bubbles.

10. The aeration device of claim 2, wherein said excess air exits said aeration device substantially only through said exhaust, and substantially no excess air exits said aeration device through said water discharge.

11. The aeration device of claim 2, wherein said water discharge comprises a water discharge exit nozzle, and further wherein said entrainment chamber comprises an upper portion that is substantially filled with excess air, and a lower portion that is substantially filled water enriched with dissolved air.

12. The aeration device of claim 11, wherein said water discharge exit nozzle is at a lower elevation than said upper portion.

13. The aeration device of claim 11, wherein said water discharge exit nozzle is laterally angled so as to impart rotation to said aeration device during normal operation.

14. The aeration device of claim 2, wherein said exhaust comprises a primary exhaust and a secondary exhaust, wherein said primary exhaust is at a higher elevation than said secondary exhaust.

15. The aeration device of claim 2, wherein said exhaust comprises an auxiliary exhaust, and wherein said auxiliary exhaust is controlled by a pressure release valve.

16. The aeration device of claim 2, wherein said exhaust stack comprises an exhaust stack adjuster that permits adjusting the total length of said exhaust stack.

17. The aeration device of claim 2, further comprising a float that maintains said aeration device at the desired level and in the desired orientation within said body of water.
